(19) United States
(12) Patent Application Publication
(10) Pub. No.: US 2007/0247295 A1
(43) Pub. Date: Oct. 25, 2007

(54) Indicating device and a combined vehicle indicating cluster

(75) Inventors: Axel Donath, Muenchen (DE); Robert Isele, Fuerstenfeldbruck (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/636,681

(22) Filed: Dec. 11, 2006

(30) Foreign Application Priority Data
Dec. 10, 2005 (DE) 10 2005 059 092.6

(51) Int. Cl. G09F 9/00

(52) U.S. Cl. 340/461

(57) ABSTRACT

An indicating device is provided having a first indicating subunit, which is based on a liquid crystal display, at least a second indicating subunit, which is based on an active light source, without using a liquid crystal display, and a first polarizing filter, which covers the first and the second indicating subunits. Such an indicating device is for use in a vehicle, such as for at least part of the instrument cluster.

### BACKGROUND AND SUMMARY OF THE INVENTION

This application claims the priority of German Application No. 10 2005 059 092.6, filed Dec. 10, 2005, the disclosure of which is expressly incorporated by reference herein.

The invention relates to an indicating device and a combined indicating device for use in vehicles.

A plethora of different types of indicating devices exist in the vehicle sector. Hence, different types of indicating devices are also frequently installed inside a vehicle.

Development efforts have concentrated not only on the ease with which the information can be read from the indicating devices, and the minimization of the production or integration costs, but also on the attractive and aesthetic look of the individual indicating devices or a combination of the indicating devices.

There is therefore needed a combination of different types of indicating devices that is simple and effective.

These needs, and others, are met by an indicating device including a first indicating subunit, which is based on a liquid crystal display, at least a second indicating subunit, which is based on an active light source without using a liquid crystal display, and a first polarizing filter, which covers both the first and the second indicating subunits. Advantageous further developments of the invention are disclosed and claimed herein.

Advantageously, the present invention is based on a combination of a first liquid crystal-based indicating subunit and a second non-liquid crystal-based indicating subunit. A polarizing filter, which is required for the first liquid crystal-based indicating subunit, and whose polarizing effect is not required for the second indicating subunit, is, nevertheless, laid preferably at least partially over said second indicating subunit.

The invention also makes it possible to reach the goal that the surface of the entire combined indicating device that is visible to the user may be designed so as to be continuous. When the indicating device is in the off state, a transition between the first indicating subunit and the second indicating subunit can be invisible or hardly visible to the user. There is no need for a cover element, which is laid over the seam, border or interface between the first and the second indicating subunits and which is visible to the user. This simplifies the production or integration of the indicating device. In addition, the indicating device may be designed in an attractive manner.

Preferably, a second polarizing filter lies on the side of the first indicating subunit that is opposite the first polarizing filter. In order to realize in particular the first liquid crystal-based indicating subunit, the second polarizing filter covers the first indicating subunit and not the second indicating subunit in order to enable here, preferably, the integration of active light sources and the partitions and/or in order to enable the light, coming from the active light sources, to pass through the first polarizing filter.

The first polarizing filter and the second polarizing filter form, preferably, the polarizing filters that are necessary in any event in order to realize the liquid crystal display. Thus, the liquid crystal display element, which is back lit preferably by a back-light, is made preferably in essence of electrodes, two supporting plates and liquid crystals, which are sandwiched in-between, without having to exhibit any other polarizing filters over the first and second polarizing filters.

Preferably, the active light source is based on at least one light emitting diode. Several adjacent light emitting diodes, having in particular different colors and/or different characters for back lighting, are separated from each other as visually as possible by way of partitions, which are arranged perpendicular to the polarizing filters.

Preferably, the section of the first polarizing filter that covers the second indicating device is partially covered with a non-transparent layer, for example a paint, which is as opaque to light as possible, or a foil, which is as opaque to light as possible. Within the scope of the invention, a “non-transparent layer” is also defined as a layer that is, in essence, opaque in the visible light range. The non-transparent layer may lie on or under the first polarizing filter.

It is especially preferred that the non-transparent layer be designed as a function of predefined characters, which can be displayed by the second indicating subunit. Therefore, the non-transparent layer may cover, in principle, the second indicating subunit, but may exhibit recesses, which match the predefined characters, which can be displayed by the second indicating subunit. Owing to the back lighting of the second indicating subunit, for example, by means of the aforementioned diodes, the back lighting being concentrated in particular on the recesses, the characters are displayed then to the user in a visible or accentuated manner.

According to a further preferred embodiment, the section of the first polarizing filter that covers the first indicating subunit is partially covered with a non-transparent layer, which frames the visible section of the first indicating subunit. Hence, when the indicating device is in the on-state, the first indicating subunit is visually separated from the second indicating subunit without having to show the visual separation also in the off-state of the indicating device. In this case the non-transparent layer may also lie on or under the first polarizing filter.

Preferably, the first polarizing filter is constructed so as to be flat or in one piece and/or exhibits a flat surface, directed toward the user.

Within the scope of the invention, there are also, of course, indicating devices, which exhibit not only the aforementioned indicating subunits but also other indicating elements, which exhibit additional electronic or mechanical components, and/or which exhibit additional foils, filters or coatings.

The needs are met, in particular, by a combined vehicle indicating device having the inventive indicating device and an additional, in particular pointer-based, analog indicating element. Thus, the first polarizing filter of the indicating device exhibits at least one recess for accommodating additional indicating elements. The result is a simple and visually attractive integration of the inventive indicating device in a vehicle.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic drawing of a sectional view of an indicating device according to the invention;

FIG. 2 is a schematic drawing of the indicating device according to the invention;

FIG. 3 is a simplified drawing of a sectional view of the indicating device according to the invention; and

FIG. 4 depicts two variants of combined vehicle indicating devices according to the invention in two operating states.

### DETAILED DESCRIPTION OF THE DRAWINGS

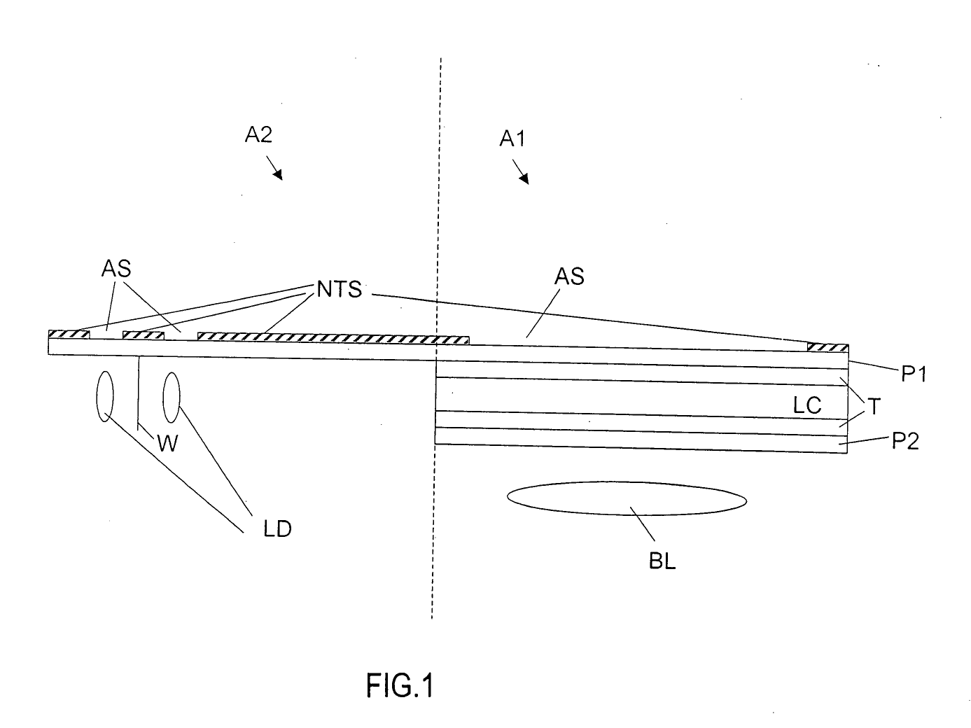

FIG. 1 is a schematic drawing of a sectional view of an indicating device, having two indicating subunits A1, A2.

The first liquid crystal-based indicating subunit A1 is shown on the right of the dashed line. It is based on a liquid crystal layer LC, which is enclosed at its top and bottom by a supporting plate T, which is made, for example, of glass.

The top supporting plate T is covered by a first polarizing filter P1 (polarizer). The bottom supporting plate T is covered by a second polarizing filter P2. The liquid crystal-based indicating subunit A1 is back lit by a light source BL (back light), for example, by way of a light guide plate, fed by an illuminate light tube.

In addition, the first indicating subunit A1 has additional components, which are typical of liquid crystal-based indicating devices, such as LCDs (liquid crystal displays), the operating mode of which is as readily understood by a person skilled in the art as is the liquid crystal-based indicating device and, hence, the details of which are not discussed herein.

The second indicating subunit A2 is shown to the left of the dashed line. It is back lit, in particular section-by-section, by an active light source, such as one or more light emitting diodes LD. The light emitting diodes LD, which back light the various sections of the second indicating subunit A2, are separated from each other by a partition W in such a manner that they exhibit as small a negative impact as possible on each other (or disturb each other as little as possible) from a visual perspective.

The aforementioned first polarizing filter P1, which covers all or a part of the first indicating subunit A1, is constructed as one piece or flat or with a flat surface such that it also covers all or a part of the second indicating subunit A2. At the same time, additional layers or foils (not depicted) may or may not lie-depending on the embodiment—between the light source LD and the polarizing filter P1.

A non-transparent layer NTS, which is constructed as a foil or paint, is arranged (shown with shaded lines) on the first polarizing filter P1. The non-transparent layer exhibits defined recesses AS. Of course, the thickness of the layer shown in the figure is exaggerated and does not match the thickness of a actual layer.

The recesses AS in the region of the first indicating subunit A1 form the area of the liquid crystal-based indicating subunit A1 that is framed by the non-transparent layer NTS and which is visible to the user.

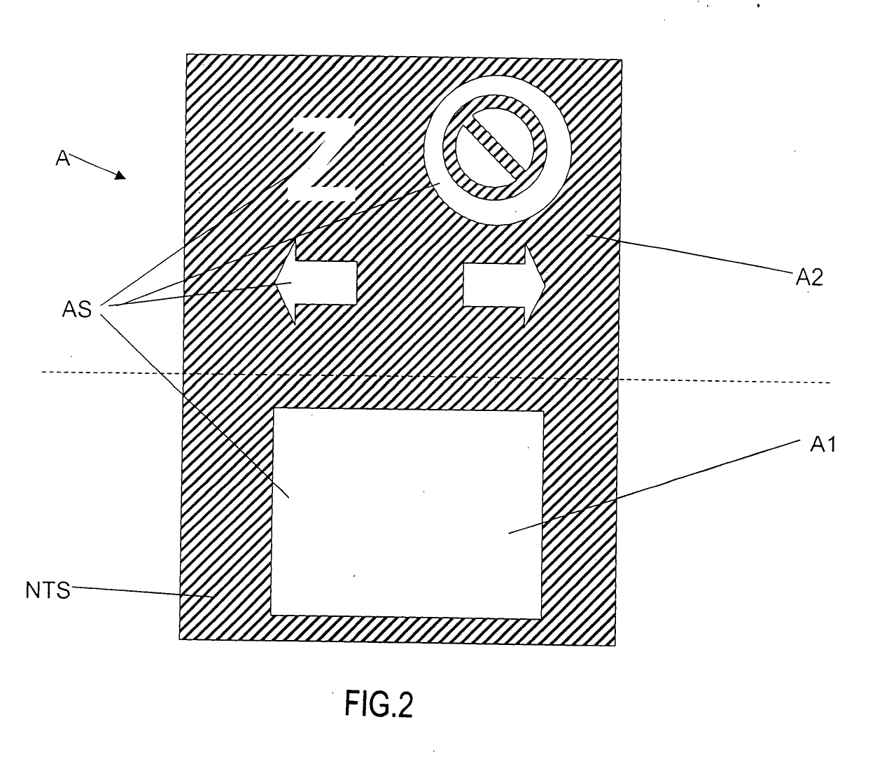

FIG. 2 is a simplified top view of an indicating device A, which includes two indicating subunits A1, A2 and which may or may not correspond—depending on the design variant—to the indicating device, according to FIG. 1.

The first liquid crystal-based indicating subunit A1 is shown below the dashed line. Here, user sees a region of the liquid crystal-based indicating subunit A1, which is framed (shown with shaded lines) by the non-transparent layer NTS, through the recess AS.

The second indicating subunit A2 is shown above the dashed line. Here, predefined characters or symbols match the recesses AS and are visible or preferably visible to the user at least when the light source LD, mounted behind the matching recess AS, is active. In addition, a subregion of the recess may be covered, as a function of the shape of a character or symbol, by, for example, another non-transparent layer in a recess AS.

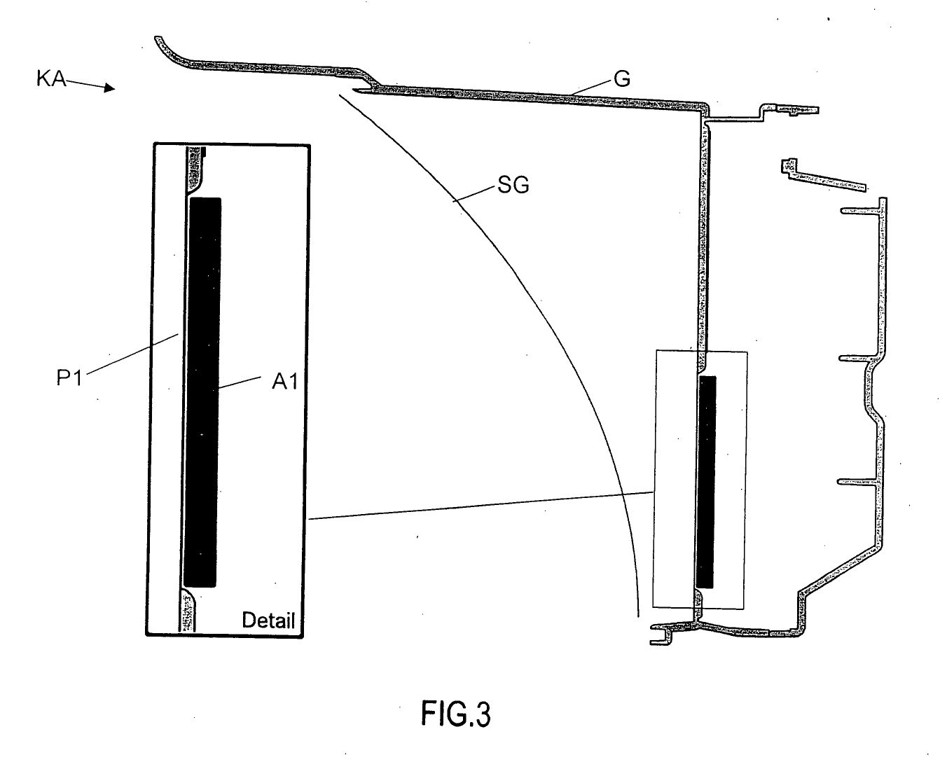

FIG. 3 is a simplified sectional drawing view of an indicating device A for a vehicle. The indicating device may or may not correspond—depending on the design variant—to the indicating device, according to FIG. 1 and/or FIG. 2.

The indicating device, of which only a part of the first liquid crystal-based indicating subunit A1 is depicted, is built behind safety glass SG in a housing G, which bears the indicating instruments of the vehicle. This first indicating subunit A1 is covered by a polarizing filter P1. The polarizing filter P1 extends beyond the first liquid crystal-based indicating subunit A1 and also covers a second indicating subunit, which lies above the first liquid crystal-based indicating subunit (not shown in the figure).

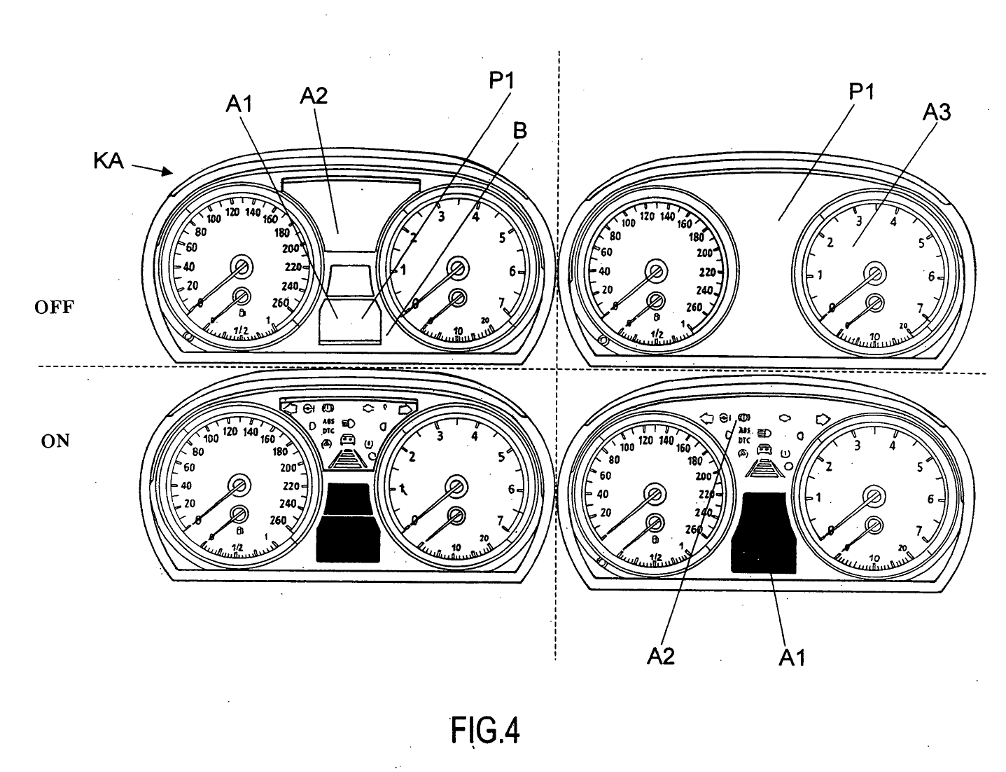

FIG. 4 shows two alternatives of combined vehicle indicating devices KA in the two operating states OFF (above the dashed line) and ON (below the dashed line). The operating state relates, for example, to the back lighting or the ignition.

A conventional combined vehicle indicating device KA, wherein only the liquid crystal-based indicating subunit A1 is covered by a polarizing filter P1, is shown to the left of the dashed line. The region of the indicating subunit A1 that is visible to the user is framed by an aperture B, which also forms the transition between the first A1 and the second indicating subunit A2. The indicating subunits A1, A2 may or may not correspond—depending on the design variant—to the indicating subunits, according to FIGS. 1, 2 and/or 3.

A combined vehicle indicating device KA according to the invention is shown to the right of the dashed line. Here, the liquid crystal-based indicating subunit A1 and the second indicating subunit A2 are covered by a polarizing filter P1. In addition, the polarizing filter P1 exhibits recesses for additional, in particular pointer-based (dial-gauge), analog indicating elements A3.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An indicating device, comprising:
a first indicating subunit based upon a liquid crystal display;
at least a second indicating subunit based on an active light source, which is not a liquid crystal display; and
a first polarizing filter operatively arranged to cover the first indicating subunit and the second indicating subunit.

2. The indicating device according to claim 1, wherein the liquid crystal display comprises first and second supporting plates between which is sandwiched liquid crystals.

3. The indicating device according to claim 1, further comprising a second polarizing filter operatively arranged on a side of the first indicating subunit that is opposite a side covered by the first polarizing filter.

4. The indicating device according to claim 2, further comprising a second polarizing filter operatively arranged on a side of the first indicating subunit that is opposite a side covered by the first polarizing filter.

5. The indicating device according to claim 3, wherein the second polarizing filter covers only the first indicating subunit.

6. The indicating device according to claim 4, wherein the second polarizing filter covers only the first indicating subunit.

7. The indicating device according to claim 1, wherein the active light source is based upon at least one light emitting diode.

8. The indicating device according to claim 1, wherein a section of the first polarizing filter covering at least a portion of the second indicating subunit is partially covered with a non-transparent layer.

9. The indicating device according to claim 8, wherein the non-transparent layer has a design based upon predefined characters, which predefined characters are displayable by the second indicating subunit.

10. The indicating device according to claim 1, wherein a section of the first polarizing filter covering the first indicating subunit is partially covered with a non-transparent layer, which non-transparent layer frames a visible section of the first indicating subunit.

11. The indicating device according to claim 8, wherein a section of the first polarizing filter covering the first indicating subunit is partially covered with a non-transparent layer, which non-transparent layer frames a visible section of the first indicating subunit.

12. The indicating device according to claim 9, wherein a section of the first polarizing filter covering the first indicating subunit is partially covered with a non-transparent layer, which non-transparent layer frames a visible section of the first indicating subunit.

13. The indicating device according to claim 1, wherein the first polarizing filter is at least one of made in one-piece and defined by a flat surface.

14. The indicating device according to claim 12, wherein the first polarizing filter is at least one of made in one-piece and defined by a flat surface.

15. The indicating device according to claim 1, further comprising:
an additional indicating element; and
wherein the first polarizing filter covering the first and second indicating subunits of the indicating device has at least one recess for accommodating the additional indicating element.

16. The indicating device according to claim 2, further comprising:
an additional indicating element; and
wherein the first polarizing filter covering the first and second indicating subunits of the indicating device has at least one recess for accommodating the additional indicating element.

17. The indicating device according to claim 12, further comprising:
an additional indicating element; and
wherein the first polarizing filter covering the first and second indicating subunits of the indicating device has at least one recess for accommodating the additional indicating element.

18. The indicating device according to claim 15, wherein the additional indicating element is a vehicle instrument.

19. The indicating device according to claim 18, wherein the vehicle instrument is an analog indicating element.

20. A vehicle instrument cluster display, comprising:
an indicating device having a first indicating subunit based on a liquid crystal display and at least a second indicating subunit based on an active light source different from the liquid crystal display, wherein a first polarizing filter covers the first and the second indicating subunits on a side facing a vehicle user when installed; and
an analog indicating element arranged in a recess of the first polarizing filter, the analog indicating element being at least one of a speedometer, tachometer, and a dial gauge.
